(19) United States
(12) Patent Application Publication
(10) Pub. No.: US 2018/0054329 A1
(43) Pub. Date: Feb. 22, 2018

(54) Channel Estimation Method, Apparatus, and System

(71) Applicant: Huawei Technologies Co., Ltd., Shenzhen (CN)

(72) Inventors: Min Yan, Shenzhen (CN); Xin Xue, Shenzhen (CN)

(21) Appl. No.: 15/795,577

(22) Filed: Oct. 27, 2017

Related U.S. Application Data
(63) Continuation of application No. PCT/CN2015/077674, filed on Apr. 28, 2015.

(51) Int. Cl. H04L 25/02

(52) U.S. Cl. CPC H04L 25/0202; H04B 7/0413

(57) ABSTRACT

A method includes receiving, by two receivers respectively, a first channel estimation sequence from a first transmitter and a second channel estimation sequence from a second transmitter, where the second channel estimation sequence is a sequence that is orthogonal to the first channel estimation sequence and an auto-correlation function is an impulse function when channels are estimated thereby signals obtained based on auto-correlation of the first channel estimation sequence and on auto-correlation of the second channel estimation sequence are impulse signals, and a convolution between the first channel estimation sequence and the second channel estimation sequence is 0.

### CROSS-REFERENCE TO RELATED APPLICATIONS

This application is a continuation application of International Patent Application No. PCT/CN2015/077674, filed on Apr. 28, 2015, the disclosure of which is hereby incorporated by reference in its entirety.

### TECHNICAL FIELD

The present disclosure relates to wireless communications technologies, and in particular, to a channel estimation method, an apparatus, and a system.

### BACKGROUND

With the advent of the age of big data, people have a higher requirement on a data transmission rate. For example, in application scenarios such as a big-data center, an airport, and transmission of a family high-definition television program, a higher transmission rate is required to meet user requirements. The Institute of Electrical and Electronics Engineers (IEEE) 802.11ad standard in the existing 60Gigahertz (60G) high-frequency Wireless Fidelity (WI-FI) is a single-input single-output (SISO) system. Therefore, the existing 60G high-frequency WI-FI technology cannot meet people's requirement on the transmission rate.

Therefore, a more advanced communications technology, for example, a multiple-input multiple-output (MIMO) technology is required to meet the people's requirement on the transmission rate. In addition, there are rich frequency resources at high-frequency bands, which can provide necessary channel bandwidth for high-rate transmission. With the development of the high-frequency technology, introduction of the MIMO technology to the next-generation 60G high frequency WI-FI technology is irresistible, and channel estimation based on the introduced MIMO technology becomes a new research subject.

In other approaches, a spatial orthogonal matrix in a frequency domain may be used for channel estimation based on the introduced MIMO technology. For example, a channel estimation sequence Very High Throughput Long Training Field (VHF-LTF) in IEEE 802.11ac may be used. One spatial orthogonal sequence may be used to spatially separate sub-channels, so as to implement channel estimation.

When the foregoing method is used to implement channel estimation, if there are N×N MIMO channels, N VHT-LTFs need to be consecutively sent to perform accurate channel estimation on the channels. Consequently, a relatively large processing delay is caused, and system overheads are increased.

### SUMMARY

Embodiments of the present disclosure provide a channel estimation method, an apparatus, and a system, so as to overcome problems with other approaches that a relatively large processing delay is caused in channel estimation and system overheads are increased.

A first aspect of the present disclosure provides a channel estimation method, where the method is applied to a 2×2 MIMO system, and the method includes receiving, by a receive end, target signal respectively by using two receiving units, where the target signal are signal sequences obtained after source signal sequences sent by two transmitters at a transmit end have been transmitted on a channel, the source signal sequences include a first channel estimation sequence to be sent by a first transmitter at the transmit end and a second channel estimation sequence to be sent by a second transmitter, and the first channel estimation sequence is a channel estimation sequence in the IEEE 802.11ad protocol; the second channel estimation sequence is orthogonal to the first channel estimation sequence, and an auto-correlation function of the second channel estimation sequence is an impulse function; and the target signal include target channel estimation sequences, each of the target channel estimation sequences is a signal sequence generated by adding up a first transmission channel estimation sequence and a second transmission channel estimation sequence, the first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel; and estimating, by the receive end, 2×2 channels between the two transmitters and the two receiving units according to the target channel estimation sequences, the first channel estimation sequence, and the second channel estimation sequence.

With reference to the first aspect, in a first possible implementation manner of the first aspect, the first channel estimation sequence is a sequence obtained by combining a Golay sequence a and a Golay sequence b in the IEEE 802.11ad protocol, the second channel estimation sequence is a new sequence obtained by combining the Golay sequence a and the Golay sequence b in the IEEE 802.11ad protocol, and an order of the Golay sequence a and the Golay sequence b in the second channel estimation sequence is reverse to an order of the Golay sequence a and the Golay sequence b in the first channel estimation sequence.

With reference to the first possible implementation manner of the first aspect, in a second possible implementation manner of the first aspect, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

With reference to any one of the first aspect, or the first or the second possible implementation manner of the first aspect, in a third possible implementation manner of the first aspect, estimating, by the receive end, 2×2 channels between the two transmitters and the two receiving units according to the target channel estimation sequences, the first channel estimation sequence, and the second channel estimation sequence includes performing, by the receive end, a convolution operation on a target channel estimation sequence received by an a^{th} receiving unit and the first channel estimation sequence, to obtain an estimation result of a channel between the first transmitter and the a^{th} receiving unit, where a is 1 or 2; and performing, by the receive end, a convolution operation on the target channel estimation sequence received by the a^{th} receiving unit and the second channel estimation sequence, to obtain an estimation result of a channel between the second transmitter and the a^{th} receiving unit, where a is 1 or 2.

A second aspect of the present disclosure provides a channel estimation method, where the method is applied to a 2×2 MIMO system, and the method includes sending, by a first transmitter at a transmit end, a first source signal sequence, where the first source signal sequence includes a first channel estimation sequence to be sent by the first transmitter, and the first channel estimation sequence is a channel estimation sequence in the IEEE 802.11ad protocol; and sending, by a second transmitter at the transmit end, a second source signal sequence, where the second source signal sequence includes a second channel estimation sequence to be sent by the second transmitter, the second channel estimation sequence is orthogonal to the first channel estimation sequence, and an auto-correlation function of the second channel estimation sequence is an impulse function.

With reference to the second aspect, in a first possible implementation manner of the second aspect, the first channel estimation sequence is a sequence obtained by combining a Golay sequence a and a Golay sequence b in the IEEE 802.11ad protocol, the second channel estimation sequence is a new sequence obtained by combining the Golay sequence a and the Golay sequence b in the IEEE 802.11ad protocol, and an order of the Golay sequence a and the Golay sequence b in the second channel estimation sequence is reverse to an order of the Golay sequence a and the Golay sequence b in the first channel estimation sequence.

With reference to the first possible implementation manner of the second aspect, in a second possible implementation manner of the second aspect, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

A third aspect of the present disclosure provides a receive end device, where the receive end device is applied to a 2×2 MIMO system, and includes two receiving units, configured to receive target signal, where the target signal are signal sequences obtained after source signal sequences sent by two transmitters at a transmit end have been transmitted on a channel, the source signal sequences include a first channel estimation sequence to be sent by a first transmitter at the transmit end and a second channel estimation sequence to be sent by a second transmitter, and the first channel estimation sequence is a channel estimation sequence in the IEEE 802.11ad protocol; the second channel estimation sequence is orthogonal to the first channel estimation sequence, and an auto-correlation function of the second channel estimation sequence is an impulse function; and the target signal include target channel estimation sequences, each of the target channel estimation sequences is a signal sequence generated by adding up a first transmission channel estimation sequence and a second transmission channel estimation sequence, the first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel; and a processor, configured to estimate 2×2 channels between the two transmitters and the two receiving units according to the target channel estimation sequences, the first channel estimation sequence, and the second channel estimation sequence.

With reference to the third aspect, in a first possible implementation manner of the third aspect, the first channel estimation sequence is a sequence obtained by combining a Golay sequence a and a Golay sequence b in the IEEE 802.11ad protocol, the second channel estimation sequence is a new sequence obtained by combining the Golay sequence a and the Golay sequence b in the IEEE 802.11ad protocol, and an order of the Golay sequence a and the Golay sequence b in the second channel estimation sequence is reverse to an order of the Golay sequence a and the Golay sequence b in the first channel estimation sequence.

With reference to the first possible implementation manner of the third aspect, in a second possible implementation manner of the third aspect, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

With reference to any one of the third aspect, or the first or the second possible implementation manner of the third aspect, in a third possible implementation manner of the third aspect, the processor is configured to perform a convolution operation on a target channel estimation sequence received by an a^{th} receiving unit and the first channel estimation sequence, to obtain an estimation result of a channel between the first transmitter and the a^{th} receiving unit, where a is 1 or 2; and, a convolution operation on the target channel estimation sequence received by the a^{th} receiving unit and the second channel estimation sequence, to obtain an estimation result of a channel between the second transmitter and the a^{th} receiving unit, where a is 1 or 2.

A fourth aspect of the present disclosure provides a transmit end device, where the transmit end device is applied to a 2×2 multiple-input multiple-output MIMO system, and includes a first transmitter, configured to send a first source signal sequence, where the first source signal sequence includes a first channel estimation sequence to be sent by the first transmitter, and the first channel estimation sequence is a channel estimation sequence in the IEEE 802.11ad protocol; and a second transmitter, configured to send a second source signal sequence, where the second source signal sequence includes a second channel estimation sequence to be sent by the second transmitter, the second channel estimation sequence is orthogonal to the first channel estimation sequence, and an auto-correlation function of the second channel estimation sequence is an impulse function.

With reference to the fourth aspect, in a first possible implementation manner of the fourth aspect, the first channel estimation sequence is a sequence obtained by combining a Golay sequence a and a Golay sequence b in the IEEE 802.11ad protocol, the second channel estimation sequence is a new sequence obtained by combining the Golay sequence a and the Golay sequence b in the IEEE 802.11ad protocol, and an order of the Golay sequence a and the Golay sequence b in the second channel estimation sequence is reverse to an order of the Golay sequence a and the Golay sequence b in the first channel estimation sequence.

With reference to the first possible implementation manner of the fourth aspect, in a second possible implementation manner of the fourth aspect, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

A fifth aspect of the present disclosure provides a receive end device, where the receive end device is applied to a 2×2 MIMO system, and includes two receiving units, a memory, and a processor, where the two receiving units are configured to receive target signal, where the target signal are signal sequences obtained after source signal sequences sent by two transmitters at a transmit end have been transmitted on a channel, the source signal sequences include a first channel estimation sequence to be sent by a first transmitter at the transmit end and a second channel estimation sequence to be sent by a second transmitter, and the first channel estimation sequence is a channel estimation sequence in the IEEE 802.11ad protocol; the second channel estimation sequence is orthogonal to the first channel estimation sequence, and an auto-correlation function of the second channel estimation sequence is an impulse function; and the target signal include target channel estimation sequences, each of the target channel estimation sequences is a signal sequence generated by adding up a first transmission channel estimation sequence and a second transmission channel estimation sequence, the first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel; and the memory is configured to store a group of code, and the code is used to control the processor to perform the following action including estimating 2×2 channels between the two transmitters and the two receiving units according to the target channel estimation sequences, the first channel estimation sequence, and the second channel estimation sequence.

With reference to the fifth aspect, in a first possible implementation manner of the fifth aspect, the first channel estimation sequence is a sequence obtained by combining a Golay sequence a and a Golay sequence b in the IEEE 802.11ad protocol, the second channel estimation sequence is a new sequence obtained by combining the Golay sequence a and the Golay sequence b in the IEEE 802.11ad protocol, and an order of the Golay sequence a and the Golay sequence b in the second channel estimation sequence is reverse to an order of the Golay sequence a and the Golay sequence b in the first channel estimation sequence.

With reference to the first possible implementation manner of the fifth aspect, in a second possible implementation manner of the fifth aspect, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

With reference to any one of the fifth aspect, or the first or the second possible implementation manner of the fifth aspect, in a third possible implementation manner of the fifth aspect, the processor is configured to perform a convolution operation on a target channel estimation sequence received by an a^{th} receiving unit and the first channel estimation sequence, to obtain an estimation result of a channel between the first transmitter and the a^{th} receiving unit, where a is 1 or 2; and, a convolution operation on the target channel estimation sequence received by the a^{th} receiving unit and the second channel estimation sequence, to obtain an estimation result of a channel between the second transmitter and the a^{th} receiving unit, where a is 1 or 2.

A sixth aspect of the present disclosure provides a transmit end device, where the transmit end device is applied to a 2×2 MIMO system, and includes a memory, a processor, and two transmitters, where the memory is configured to store a group of code, and the code is used by the processor to control the two transmitters to perform the following actions including sending, by a first transmitter, a first source signal sequence, where the first source signal sequence includes a first channel estimation sequence to be sent by the first transmitter, and the first channel estimation sequence is a channel estimation sequence in the IEEE 802.11ad protocol; and sending, by a second transmitter, a second source signal sequence, where the second source signal sequence includes a second channel estimation sequence to be sent by the second transmitter, the second channel estimation sequence is orthogonal to the first channel estimation sequence, and an auto-correlation function of the second channel estimation sequence is an impulse function.

With reference to the sixth aspect, in a first possible implementation manner of the sixth aspect, the first channel estimation sequence is a sequence obtained by combining a Golay sequence a and a Golay sequence b in the IEEE 802.11ad protocol, the second channel estimation sequence is a new sequence obtained by combining the Golay sequence a and the Golay sequence b in the IEEE 802.11ad protocol, and an order of the Golay sequence a and the Golay sequence b in the second channel estimation sequence is reverse to an order of the Golay sequence a and the Golay sequence b in the first channel estimation sequence.

With reference to the first possible implementation manner of the sixth aspect, in a second possible implementation manner of the sixth aspect, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

A seventh aspect of the present disclosure provides a channel estimation system, including the receive end device according to any one of the third aspect, or the first to the third possible implementation manners of the third aspect, and the receive end device according to any one of the fifth aspect, or the first to the third possible implementation manners of the fifth aspect; and/or the transmit end device according to any one of the fourth aspect, or the first or the second possible implementation manner of the fourth aspect, and the transmit end device according to any one of the sixth aspect, or the first or the second possible implementation manner of the sixth aspect.

In the present disclosure, a receive end receives a target signal respectively by using two receiving units. The target signal are signal sequences obtained after source signal sequences sent by two transmitters at a transmit end have been transmitted on a channel. The source signal sequences include a first channel estimation sequence to be sent by a first transmitter at the transmit end and a second channel estimation sequence to be sent by a second transmitter. The first channel estimation sequence is a channel estimation sequence in the IEEE 802.11ad protocol, and the second channel estimation sequence is a sequence that is orthogonal to the first channel estimation sequence and whose auto-correlation function is an impulse function. The target signal includes target channel estimation sequences. Each of the target channel estimation sequences is a signal sequence generated by adding up a first transmission channel estimation sequence and a second transmission channel estimation sequence, the first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel. Then, the receive end estimates 2×2 channels between the two transmitters and the two receiving units according to the target channel estimation sequences, the first channel estimation sequence, and the second channel estimation sequence. Because the second channel estimation sequence is a sequence that is orthogonal to the first channel estimation sequence and whose auto-correlation function is an impulse function, when channels are estimated, a signal obtained based on auto-correlation of the first channel estimation sequence is an impulse signal, a signal obtained based on auto-correlation of the second channel estimation sequence is also an impulse signal, and convolution between the first channel estimation sequence and the second channel estimation sequence is 0. In this way, 2×2 MIMO channels can be accurately estimated. Because the first channel estimation sequence is a channel estimation sequence in the IEEE 802.11ad protocol, the second channel estimation sequence obtained accordingly may not increase storage overheads of the transmitters.

### BRIEF DESCRIPTION OF DRAWINGS

To describe the technical solutions in the embodiments of the present disclosure more clearly, the following briefly describes the accompanying drawings required for describing the embodiments or the other approaches. The accompanying drawings in the following description show some embodiments of the present disclosure, and persons of ordinary skill in the art may still derive other drawings from these accompanying drawings without creative efforts.

FIG. 1 shows a schematic structural diagram of a data frame that is sent to a single receiving unit at a receive end by a single transmitter at a transmit end;

FIG. 2 shows a schematic structural diagram of a 2×2 MIMO system.

FIG. 3 shows a flowchart of a channel estimation method according to an embodiment of the present disclosure;

FIG. 4 shows a diagram of simulation results of an auto-correlation characteristic of CE_sq2 and a characteristic of cross correlation between CE_sq2 and CE_sq1;

FIG. 5 shows a diagram of simulation results of an auto-correlation characteristic of CE_sq1 and a characteristic of cross correlation between CE_sq1 and CE_sq2;

FIG. 6 shows a schematic diagram of a sent channel estimation sequence;

FIG. 7 shows a schematic structural diagram of a receive end device according to an embodiment of the present disclosure;

FIG. 8 shows a schematic structural diagram of a receive end device according to another embodiment of the present disclosure; and

FIG. 9 shows a schematic structural diagram of a transmit end device according to an embodiment of the present disclosure.

### DESCRIPTION OF EMBODIMENTS

To make the objectives, technical solutions, and advantages of the embodiments of the present disclosure clearer, the following describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

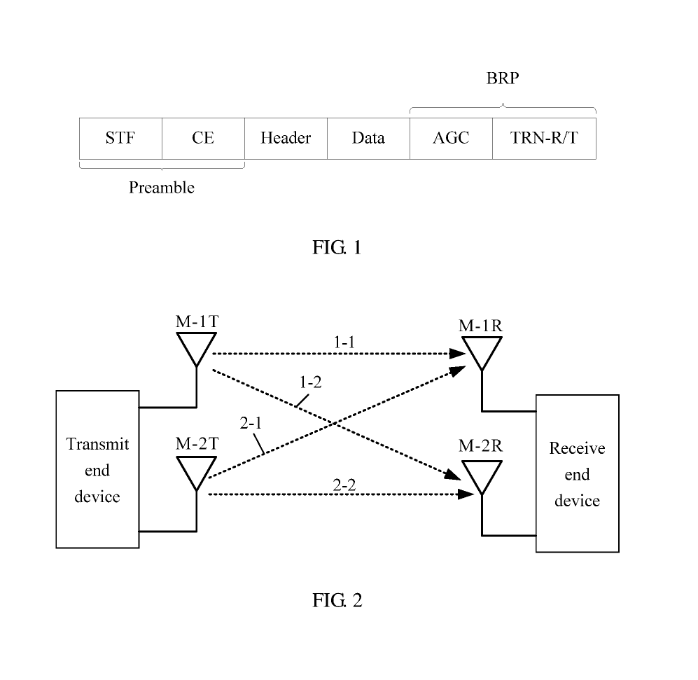

FIG. 1 shows a schematic structural diagram of a data frame that is sent to a single receiving unit at a receive end by a single transmitter at a transmit end. In a SISO system supported by the existing standard IEEE 802.11ad, a data frame that is sent to a single receiving unit at a receive end by a single transmitter at a transmit end is shown in FIG. 1, and includes a preamble, a header, data, a beam refinement protocol (BRP), and the like. The preamble includes a short training field (STF) sequence and a channel estimation (CE) sequence. The BRP includes automatic gain control (AGC) and a beam tracking request (TRN-R/T). A channel estimation sequence is located in the preamble field of the data frame. The channel estimation sequence includes eight Golay128 sequences, and the Golay128 sequence is a 128-bit orthogonal sequence. The Golay128 sequence includes a Golay sequence a (Ga128) and a Golay sequence b (Gb128).

FIG. 2 shows a schematic structural diagram of a 2×2 MIMO system. The MIMO system shown in FIG. 2 includes a transmit end device and a receive end device. In the schematic structural diagram shown in FIG. 2, the transmit end device includes two transmitters and the receive end device includes two receivers. The two transmitters of the transmit end device are M-1T and M-2T, and the two receivers of the receive end device are M-1R and M-2R. There are four channels between the two transmitters and the two receivers in total such as 1-1 (a channel between M-1T and M-1R), 1-2 (a channel between M-1T and M-2R), 2-1 (a channel between M-2T and M-1R), and 2-2 (a channel between M-2T and M-2R) respectively.

In the MIMO system, a target signal that is obtained after a source signal sequence has been transmitted on a channel may be received by all receivers. The source signal sequence is sent by a transmitter. For example, M-1T sends a source signal sequence, a target signal resulting from the source signal sequence transmitted over the 1-1 channel may be received by M-1R, and a target signal resulting from the source signal sequence transmitted over the 1-2 channel may be received by M-2R. In addition, target signal received by one receiver within a time period are added up together.

The method provided in the present disclosure is mainly used in the 2×2 MIMO system shown in FIG. 2, and is used to estimate the four channels shown in the figure such as 1-1, 1-2, 2-1, and 2-2.

### Embodiment 1

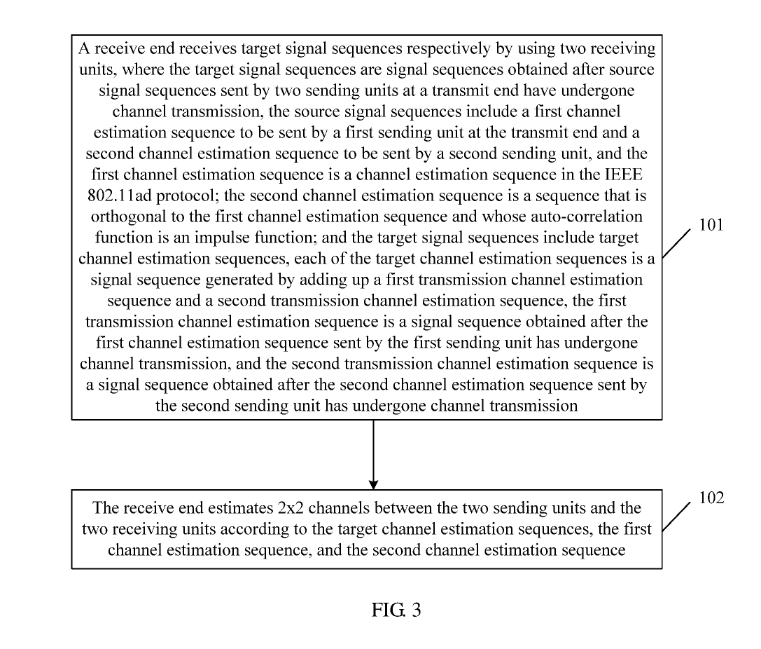

FIG. 3 shows a flowchart of a channel estimation method according to this embodiment of the present disclosure. The method shown in FIG. 3 is applied to a 2×2 MIMO system. That is, in this embodiment of the present disclosure, a receive end includes a first receiver and a second receiver, and a transmit end includes a first transmitter and a second transmitter. As shown in FIG. 1, the method in this embodiment may include the following steps.

Step 101: The receive end receives target signal respectively by using the two receivers, where the target signals are signal sequences obtained after source signal sequences sent by the two transmitters at the transmit end have been transmitted on a channel, the source signal sequences include a first channel estimation sequence to be sent by the first transmitter at the transmit end and a second channel estimation sequence to be sent by the second transmitter, and the first channel estimation sequence is a channel estimation sequence in the IEEE 802.11ad protocol; the second channel estimation sequence is a sequence that is orthogonal to the first channel estimation sequence and whose auto-correlation function is an impulse function, and the target signal include target channel estimation sequences, each of the target channel estimation sequences is a signal sequence generated by adding up a first transmission channel estimation sequence and a second transmission channel estimation sequence, the first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel.

It should be noted that, after a transmitter sends a source signal sequence over a channel, because of noise on the channel, a multipath effect, and the like, a receiver receives a target signal obtained after channel transmission, instead of the source signal sequence sent by the transmitter. In addition, target signals received by one receiver within a time period are added up together.

In this embodiment of the present disclosure, the first channel estimation sequence is a sequence obtained by combining a Ga128 and a Gb128 in the IEEE 802.11ad protocol, and the second channel estimation sequence is a new sequence obtained by combining the Ga128 and the Gb128 in the IEEE 802.11ad protocol. For ease of description, the first channel estimation sequence to be sent by the first transmitter is denoted by CE_sq1, and the second channel estimation sequence to be sent by the second transmitter is denoted by CE_sq2.

For a purpose of not increasing storage overheads of the transmit end, CE_sq1 in the present disclosure includes the Ga128 and the Gb128 in the existing IEEE 802.11ad protocol, and CE_sq2 in the present disclosure is a new channel estimation sequence designed based on the Ga128 and the Gb128 in the existing IEEE 802.11ad protocol.

That is CE_sq1=[−Gb128, −Ga128, Gb128, −Ga128, −Gb128, Ga128, −Gb128, −Ga128].

CE_sq1 includes eight elements. Therefore, there are 2⁸ combinations for elements included in CE_sq2, and CE_sq2 is represented in a weighted form as follows.

$$CE\_sq2 = [ \begin{matrix}{w}_{1} \times Gb 128 , {w}_{2} \times Ga 128 , {w}_{3} \times Gb 128 , {w}_{4} \times Ga 128 , \\ {w}_{5} \times Gb 128 , {w}_{6} \times Ga 128 , {w}_{7} \times Gb 128 , {w}_{8} \times Ga 128\end{matrix} ] ,$$

where w represents a weighted value, and may be ±1.

In the MIMO system shown in FIG. 2, a first channel estimation sequence S₁ sent by M-1T is CE_sq1, and a second channel estimation sequence S₂ sent by M-2T is CE_sq2 in this embodiment of the present disclosure. CE_sq1 is transmitted over the channel 1-1 to M-1R, and a first transmission channel estimation sequence received by M-1R is denoted by CE_sq1′. In addition, CE_sq2 is transmitted over the channel 2-1 to M-1R, and a second transmission channel estimation sequence received by M-1R is denoted by CE_sq2′. It is assumed that a target channel estimation sequence received by M-1R is a result R₁ of adding up CE_sq1′ and CE_sq2′ that are obtained after channel transmission. CE_sq1 is transmitted over the channel 1-2 to M-2R, and a first transmission channel estimation sequence received by M-2R is denoted by CE_sq1′. In addition, CE_sq2 is transmitted over the channel 2-2 to M-2R, and a second transmission channel estimation sequence received by M-2R is denoted by CE_sq2″. A target channel estimation sequence received by M-2R is a result R₂ of adding up CE_sq1″ and CE_sq2″ that are obtained after channel transmission.

In an actual application, R₁=H₁₁*S₁+H₂₁*S₂, and R₂=H₁₂*S₁+H₂₂*S₂, where H₁₁ is a time domain channel between M-1T and M-1R, H₁₂ is a time domain channel between M-1T and M-2R, H₂₁ is a time domain channel between M-2T and M-1R, H₂₂ is a time domain channel between M-2T and M-2R, H₁₁, H₁₂, H₂₁, and H₂₂ all can be represented by one-dimension vectors, and * indicates a convolution operation.

If the SISO channel estimation concept is applied to the 2×2 MIMO system in the present disclosure, H₁₁ can be estimated by using only the received signal R₁ and S₁, H₂₁ can be estimated by using only the received signal R₁ and S₂, H₁₂ can be estimated by using only the received signal R₂ and S₁, and H₂₂ can be estimated by using only the received signal R₂ and S₂.

That is, R₁*S₁=H₁₁, R₁*S₂=H₂₁, R₂*S₁=H₁₂, and R₂*S₂=H₂₂.

R₁*S₁=(H₁₁*S₁+H₂₁*S₂)*S₁=H₁₁*S₁*S₁+H₂₁*S₂*S₁. Since S₁ includes the Ga128 and Gb128 sequences in the existing IEEE 802.11ad protocol, S₁*S₁=δ. That is, R₁*S₁=H₁₁+H₂₁*S₂*S₁. In this case, H₁₁ can be obtained only by requiring that S₂*S₁=0. Therefore, S₂ and S₁ should be orthogonal, and R₁*S₁=H₁₁ when S₂ is orthogonal to S₁.

R₁*S₂=(H₁₁*S₁+H₂₁*S₂)*S₂−H₁₁*S₁*S₂+H₂₁*S₂*S₂. To satisfy that R₁*S₂=H₂₁, it is required that S₁*S₂=0 and S₂*S₂=δ. That is, S₁ and S₂ should be orthogonal, and an auto-correlation function of S₂ is an impulse function. R₁*S₂=H₂₁ only after the foregoing conditions are satisfied.

R₂*S₁=(H₁₂*S₁+H₂₂*S₂)*S₁=H₁₂*S₁*S₁+H₂₂*S₂*S₁. Since S₁ includes the Ga128 and Gb128 sequences in the existing IEEE 802.11ad protocol, S₁*S₁=δ. That is, R₂*S₁=H₁₂+H₂₂*S₂*S₁. In this case, H₁₂ can be obtained only by requiring that S₂*S₁=0. Therefore, S₂ and S₁ should be orthogonal, and R₂*S₁=H₁₂ when S₂ is orthogonal to S₁.

R₂*S₂=(H₁₂*S₁+H₂₂*S₂)*S₁=H₁₂*S₁*S₂+H₂₂*S₂*S₂. To satisfy that R₂*S₂=H₂₂, it is required that S₁*S₂=0 and S₂*S₂=δ. That is, S₁ and S₂ should be orthogonal, and an auto-correlation function of S₂ is an impulse function. R₂*S₂=H₂₂ only after the foregoing conditions are satisfied.

It can be learnt from the foregoing analysis that, the second channel estimation sequence S₂ in the present disclosure should satisfy that the auto-correlation function is an impulse function, and S₂ is orthogonal to the first channel estimation sequence.

Therefore, CE_sq2 is CE_sq2=[−Ga128, −Gb128, −Ga128, +Gb128, −Ga128, −Gb128, +Ga128, −Gb128].

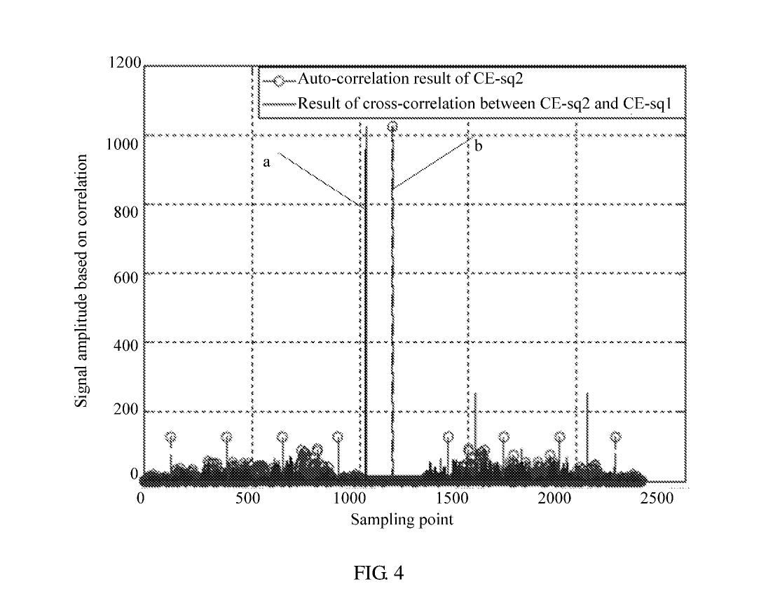

To learn more clearly an auto-correlation characteristic of CE_sq2 and a characteristic of cross correlation between CE_sq2 and CE_sq1 in the foregoing embodiment, FIG. 4 shows a diagram of simulation results of the auto-correlation characteristic of CE_sq2 and the characteristic of cross correlation between CE_sq2 and CE_sq1. In FIG. 4, horizontal coordinates represent time sampling points, and vertical coordinates represent signal amplitude based on correlation (including signal amplitude of CE_sq2 based on auto-correlation and signal amplitude of CE_sq2 and CE_sq1 based on cross-correlation). “a” represents a simulation result of cross-correlation between CE_sq2 and CE_sq1, and “b” represents a simulation result of an auto-correlation function of CE_sq2. It can be learnt from FIG. 4 that a cross-correlated sequence of CE_sq2 and CE_sq1 is 0 within 127 sampling points on both sides of a that is used as a sampling point and that indicates an impulse response, and the auto-correlation function of CE_sq2 is an impulse function. FIG. 5 shows a diagram of simulation results of an auto-correlation characteristic of CE_sq1 and a characteristic of cross correlation between CE_sq1 and CE_sq2. In FIG. 5, horizontal coordinates represent time sampling points, and vertical coordinates represent signal amplitude based on correlation (including signal amplitude of CE_sq1 based on auto-correlation and signal amplitude of CE_sq1 and CE_sq2 based on cross-correlation). “c” represents a simulation result of an auto-correlation function of CE_sq1, and “d” represents a simulation result of cross-correlation between CE_sq1 and CE_sq2. It can be learnt from FIG. 5 that the auto-correlation function of CE_sq1 is an impulse function, and a cross-correlated sequence of CE_sq1 and CE_sq2 is 0 within 127 sampling points on both sides of d that is used as a sampling point and that indicates an impulse response.

It should be noted that, for a purpose of not increasing storage overheads in the present disclosure but effectively estimating channels, a channel estimation sequence in other approaches of IEEE 802.11ad is selected as CE_sq1, and correspondingly, CE_sq2 in the present disclosure should be a sequence orthogonal to CE_sq1. However, in an actual application, CE_sq1 and CE_sq2 may be other sequences, provided that the auto-correlation function of CE_sq1 is an impulse function, the auto-correlation function of CE_sq2 is an impulse function, and CE_sq1 is orthogonal to CE_sq2, that is, a cross-correlation function of CE_sq1 and CE_sq2 are 0. The present disclosure sets no limit on specific forms of CE_sq1 and CE_sq2.

Step 102: The receive end estimates 2×2 channels between the two transmitters (or sending units) and the two receivers (or receiving units) according to the target channel estimation sequences, the first channel estimation sequence, and the second channel estimation sequence.

After the receive end receives the target channel estimation sequence R₁ and the target channel estimation sequence R₂, the receive end performs a convolution operation on the target channel estimation sequence R₁ received by the first receiver M-1R and the first channel estimation sequence S₁ sent by M-1T, to obtain an estimation result of the channel H₁₁ between the first transmitter M-1T and the first receiver M-1R; the receive end performs a convolution operation on the target channel estimation sequence R₁ received by the first receiver M-1R and the second channel estimation sequence S₂ sent by M-2T, to obtain an estimation result of the channel H₂₁ between the second transmitter M-2T and the first receiver M-1R; the receive end performs a convolution operation on the target channel estimation sequence R₂ received by the second receiver M-2R and the first channel estimation sequence S₁ sent by M-1T, to obtain an estimation result of the channel H₁₂ between the first transmitter M-1T and the second receiver M-2R; and the receive end performs a convolution operation on the target channel estimation sequence R₂ received by the second receiver M-2R and the second channel estimation sequence S₂ sent by M-2T, to obtain an estimation result of the channel H₂₂ between the second transmitter M-2T and the second receiver M-2R.

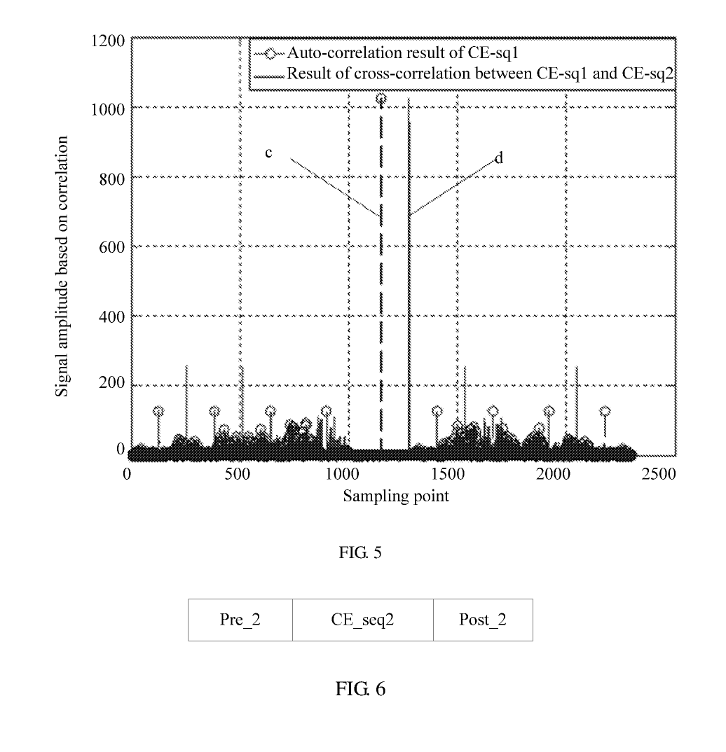

Similar to the channel estimation sequence in IEEE 802.11ad, correspondingly, a prefix and a suffix are assigned to CE_sq2 provided in the present disclosure. The prefix is represented by Pre_2, and the suffix is represented by Post_2. FIG. 6 shows a schematic diagram of a sent channel estimation sequence such as Pre_2=−Gb128, and Post_2=−Ga128.

The channel estimation method provided in this embodiment includes receiving, by a receive end, target signal respectively by using two receivers, where the target signals are signal sequences obtained after source signal sequences sent by two transmitters at a transmit end have been transmitted on a channel, the source signal sequences include a first channel estimation sequence to be sent by a first transmitter at the transmit end and a second channel estimation sequence to be sent by a second transmitter, and the first channel estimation sequence is a channel estimation sequence in the IEEE 802.11ad protocol; the second channel estimation sequence is a sequence that is orthogonal to the first channel estimation sequence and whose auto-correlation function is an impulse function; and the target signal include target channel estimation sequences, each of the target channel estimation sequences is a signal sequence generated by adding up a first transmission channel estimation sequence and a second transmission channel estimation sequence, the first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel; and estimating, by the receive end, 2×2 channels between the two transmitters and the two receivers according to the target channel estimation sequences, the first channel estimation sequence, and the second channel estimation sequence. Because the second channel estimation sequence is a sequence that is orthogonal to the first channel estimation sequence and whose auto-correlation function is an impulse function, when channels are estimated, a signal obtained based on auto-correlation of the first channel estimation sequence is an impulse signal, a signal obtained based on auto-correlation of the second channel estimation sequence is also an impulse signal, and convolution between the first channel estimation sequence and the second channel estimation sequence is 0. In this way, 2×2 MIMO channels can be accurately estimated. Because the first channel estimation sequence is a channel estimation sequence in the IEEE 802.11ad protocol, the second channel estimation sequence obtained accordingly may not increase storage overheads of the transmitters.

### Embodiment 2

This embodiment of the present disclosure provides a channel estimation method. The method is applied to a 2×2 multiple-input multiple-output MIMO system. That is, a receive end in this embodiment of the present disclosure includes a first receiver and a second receiver, and a transmit end includes a first transmitter and a second transmitter. The method in this embodiment may include the following steps. Sending, by the first transmitter at the transmit end, a first source signal sequence, where the first source signal sequence includes a first channel estimation sequence to be sent by the first transmitter, and the first channel estimation sequence is a channel estimation sequence in the IEEE 802.11ad protocol; and sending, by the second transmitter at the transmit end, a second source signal sequence, where the second source signal sequence includes a second channel estimation sequence to be sent by the second transmitter, the second channel estimation sequence is orthogonal to the first channel estimation sequence, and an auto-correlation function of the second channel estimation sequence is an impulse function.

For a purpose of reducing storage overheads of the transmitters, the first channel estimation sequence is a sequence obtained by combining a Golay sequence a (Ga128) and a Golay sequence b (Gb128) in the existing IEEE 802.11ad protocol, and the second channel estimation sequence is a new sequence obtained by combining the Ga128 and the Gb128 in the IEEE 802.11ad protocol.

That is, the first channel estimation sequence is [−Gb128, −Ga128, +Gb128, −Ga128, −Gb128, +Ga128, −Gb128, −Ga128].

However, for a purpose of accurately estimating channels, a method for selecting the second channel estimation sequence is the same as a method for selecting the second channel estimation sequence in the foregoing embodiment, and details are not described herein again.

Therefore, the second channel estimation sequence is [−Ga128, −Gb128, −Ga128, +Gb128, −Ga128, −Gb128, +Ga128, −Gb128].

The channel estimation method provided in this embodiment of the present disclosure includes sending, by a first transmitter at a transmit end, a first source signal sequence, and sending, by a second transmitter at the transmit end, a second source signal sequence, where the first source signal sequence includes a first channel estimation sequence to be sent by the first transmitter, the first channel estimation sequence is a channel estimation sequence in the IEEE 802.11ad protocol, the second source signal sequence includes a second channel estimation sequence to be sent by the second transmitter, and the second channel estimation sequence is a sequence that is orthogonal to the first channel estimation sequence and whose auto-correlation function is an impulse function. After receiving target channel estimation sequences obtained after channel transmission, a receive end can accurately estimate channels according to the target channel estimation sequences, the first channel estimation sequence, and the second channel estimation sequence. Because the second channel estimation sequence is a sequence that is orthogonal to the first channel estimation sequence and whose auto-correlation function is an impulse function, when the receive end estimates channels, a signal obtained based on auto-correlation of the first channel estimation sequence is an impulse signal, a signal obtained based on auto-correlation of the second channel estimation sequence is an impulse signal, and convolution between the first channel estimation sequence and the second channel estimation sequence is 0. In this way, 2×2 MIMO channels can be accurately estimated. Because the first channel estimation sequence is a channel estimation sequence in the IEEE 802.11ad protocol, the second channel estimation sequence obtained accordingly may not increase storage overheads of the transmitters.

### Embodiment 3

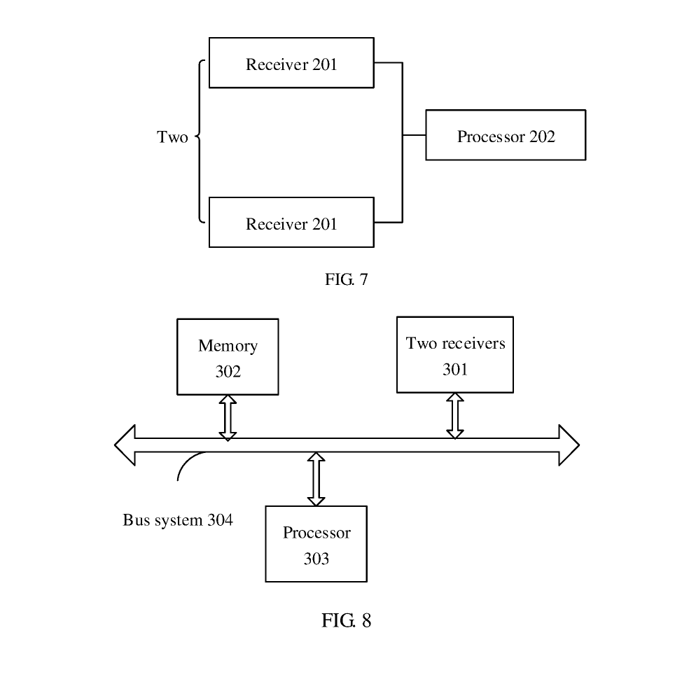

FIG. 7 shows a schematic structural diagram of a receive end device according to this embodiment of the present disclosure. The receive end device may be applied to a 2×2 MIMO system, and is configured to execute the channel estimation method shown in FIG. 3. As shown in FIG. 7, the receive end device includes two receivers 201 and a processor 202.

The two receivers 201 are configured to receive target signals. The target signals are signal sequences obtained after source signal sequences sent by two transmitters at a transmit end have been transmitted on a channel. The source signal sequences include a first channel estimation sequence to be sent by a first transmitter at the transmit end and a second channel estimation sequence to be sent by a second transmitter. The first channel estimation sequence is a channel estimation sequence in the IEEE 802.11ad protocol.

The second channel estimation sequence is orthogonal to the first channel estimation sequence, and an auto-correlation function of the second channel estimation sequence is an impulse function.

The target signal include target channel estimation sequences. Each of the target channel estimation sequences is a signal sequence generated by adding up a first transmission channel estimation sequence and a second transmission channel estimation sequence. The first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel.

The processor 202 is configured to estimate 2×2 channels between the two transmitters and the two receivers 201 according to the target channel estimation sequences, the first channel estimation sequence, and the second channel estimation sequence.

Optionally, the first channel estimation sequence is a sequence obtained by combining a Golay sequence a and a Golay sequence b in the IEEE 802.11ad protocol. The second channel estimation sequence is a new sequence obtained by combining the Golay sequence a and the Golay sequence b in the IEEE 802.11ad protocol. An order of the Golay sequence a and the Golay sequence b in the second channel estimation sequence is reverse to an order of the Golay sequence a and the Golay sequence b in the first channel estimation sequence.

Optionally, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

Optionally, the processor 202 is configured to perform a convolution operation on a target channel estimation sequence received by an a^{th} receiver 201 and the first channel estimation sequence, to obtain an estimation result of a channel between the first transmitter and the a^{th} receiver 201, where a is 1 or 2; and, a convolution operation on the target channel estimation sequence received by the a^{th} receiver 201 and the second channel estimation sequence, to obtain an estimation result of a channel between the second transmitter and the a^{th} receiver 201, where a is 1 or 2.

The receive end device in this embodiment may be configured to execute the technical solution in the method embodiment shown in FIG. 3. An implementation principle and a technical effect of the device are similar to those of the method embodiment, and details are not described herein again.

### Embodiment 4

In hardware implementation, the units in Embodiment 3 may be, in a hardware form, built in or independent of a processor of a receive end device, or may be stored in a software form in a memory of a receive end device, so that the processor invokes and performs operations corresponding to the units. The processor may be a central processor unit (CPU), a microprocessor, a single-chip microcomputer, or the like.

FIG. 8 shows a schematic structural diagram of a receive end device according to this embodiment of the present disclosure. The receive end device is configured to execute the channel estimation method shown in FIG. 3. As shown in FIG. 8, the receive end device includes two receivers 301, a memory 302, a processor 303, and a bus system 304.

The two receivers 301, the memory 302, and the processor 303 are coupled together by using the bus system 304. In addition to a data bus, the bus system 304 may further include a power bus, a control bus, a status signal bus, and the like. However, for clear description, various buses are denoted by the bus system 304 in the figure.

The two receivers 301 are configured to receive target signals. The target signals are signal sequences obtained after source signal sequences sent by two transmitters at a transmit end have been transmitted on a channel. The source signal sequences include a first channel estimation sequence to be sent by a first transmitter at the transmit end and a second channel estimation sequence to be sent by a second transmitter. The first channel estimation sequence is a channel estimation sequence in the IEEE 802.11ad protocol.

The second channel estimation sequence is orthogonal to the first channel estimation sequence, and an auto-correlation function of the second channel estimation sequence is an impulse function.

The target signals include target channel estimation sequences. Each of the target channel estimation sequences is a signal sequence generated by adding up a first transmission channel estimation sequence and a second transmission channel estimation sequence. The first transmission channel estimation sequence is a signal sequence obtained after the first channel estimation sequence sent by the first transmitter has been transmitted on a channel, and the second transmission channel estimation sequence is a signal sequence obtained after the second channel estimation sequence sent by the second transmitter has been transmitted on a channel.

The memory 302 is configured to store a group of code, and the code is used to control the processor 303 to perform the following action including estimating, by the processor 303, 2×2 channels between the two transmitters and the two receivers 301 according to the target channel estimation sequences, the first channel estimation sequence, and the second channel estimation sequence.

Optionally, the first channel estimation sequence is a sequence obtained by combining a Golay sequence a and a Golay sequence b in the IEEE 802.11ad protocol. The second channel estimation sequence is a new sequence obtained by combining the Golay sequence a and the Golay sequence b in the IEEE 802.11ad protocol. An order of the Golay sequence a and the Golay sequence b in the second channel estimation sequence is reverse to an order of the Golay sequence a and the Golay sequence b in the first channel estimation sequence.

Optionally, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

Optionally, the processor 303 is configured to perform a convolution operation on a target channel estimation sequence received by an a^{th} receiver 301 and the first channel estimation sequence, to obtain an estimation result of a channel between the first transmitter and the a^{th} receiver 301, where a is 1 or 2; and, a convolution operation on the target channel estimation sequence received by the a^{th} receiver 301 and the second channel estimation sequence, to obtain an estimation result of a channel between the second transmitter and the a^{th} receiver 301, where a is 1 or 2.

The receive end device provided in this embodiment may be configured to execute the technical solution in the method embodiment shown in FIG. 3. An implementation principle and a technical effect of the device are similar to those of the method embodiment, and details are not described herein again.

### Embodiment 5

This embodiment of the present disclosure provides a transmit end device. The transmit end device may be applied to a 2×2 t MIMO system, and is configured to execute the channel estimation method shown in Embodiment 2. The transmit end device includes two transmitters.

A first transmitter sends a first source signal sequence. The first source signal sequence includes a first channel estimation sequence to be sent by the first transmitter. The first channel estimation sequence is a channel estimation sequence in the IEEE 802.11ad protocol.

A second transmitter sends a second source signal sequence. The second source signal sequence includes a second channel estimation sequence to be sent by the second transmitter. The second channel estimation sequence is orthogonal to the first channel estimation sequence, and an auto-correlation function of the second channel estimation sequence is an impulse function.

Optionally, the first channel estimation sequence includes a Golay sequence a and a Golay sequence b in the IEEE 802.11ad protocol. The second channel estimation sequence is a new sequence obtained by combining the Golay sequence a and the Golay sequence b in the IEEE 802.11ad protocol. An order of the Golay sequence a and the Golay sequence b in the second channel estimation sequence is reverse to an order of the Golay sequence a and the Golay sequence b in the first channel estimation sequence.

Optionally, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

The transmit end device provided in this embodiment may be configured to execute the technical solution in the method embodiment shown in Embodiment 2. An implementation principle and a technical effect of the device are similar to those of the method embodiment, and details are not described herein again.

### Embodiment 6

In hardware implementation, the units in Embodiment 5 may be, in a hardware form, built in or independent of a processor of a transmit end device, or may be stored in a software form in a memory of a transmit end device, so that the processor invokes and performs operations corresponding to the units. The processor may be a CPU, a microprocessor, a single-chip microcomputer, or the like.

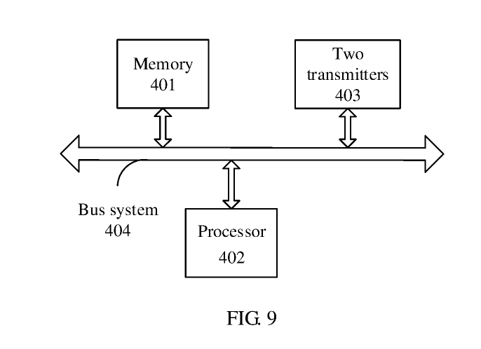

FIG. 9 shows a schematic structural diagram of a transmit end device according to this embodiment of the present disclosure. The transmit end device provided in this embodiment is configured to execute the channel estimation method shown in Embodiment 2. The transmit end device includes a memory 401, a processor 402, two transmitters 403, and a bus system 404.

The memory 401, the processor 402, and the two transmitters 403 are coupled together by using the bus system 404. In addition to a data bus, the bus system 404 may further include a power bus, a control bus, a status signal bus, and the like. However, for clear description, various buses are denoted by the bus system 404 in the figure.

The memory 401 is configured to store a group of code, and the code is used by the processor 402 to control the two transmitters 403 to perform the following actions including sending, by a first transmitter 403, a first source signal sequence, where the first source signal sequence includes a first channel estimation sequence to be sent by the first transmitter, and the first channel estimation sequence is a channel estimation sequence in the IEEE 802.11ad protocol; and sending, by a second transmitter 403, a second source signal sequence, where the second source signal sequence includes a second channel estimation sequence to be sent by the second transmitter, the second channel estimation sequence is orthogonal to the first channel estimation sequence, and an auto-correlation function of the second channel estimation sequence is an impulse function.

Optionally, the first channel estimation sequence includes a Golay sequence a and a Golay sequence b in the IEEE 802.11ad protocol. The second channel estimation sequence is a new sequence obtained by combining the Golay sequence a and the Golay sequence b in the IEEE 802.11ad protocol. An order of the Golay sequence a and the Golay sequence b in the second channel estimation sequence is reverse to an order of the Golay sequence a and the Golay sequence b in the first channel estimation sequence.

Optionally, the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

The transmit end device in this embodiment may be configured to execute the technical solution in the method embodiment shown in Embodiment 2. An implementation principle and a technical effect of the device are similar to those of the method embodiment, and details are not described herein again.

An embodiment of the present disclosure further provides a channel estimation system, including the receive end device provided in Embodiment 3 or Embodiment 4, and/or the transmit end device provided in Embodiment 5 or Embodiment 6.

In the several embodiments provided in this application, it should be understood that the disclosed system, apparatuses, and methods may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be indirect couplings or communication connections between some interfaces, apparatuses, and units, or may be implemented in electronic, mechanical, or other forms.

The units described as separate parts may or may not be physically separate. Parts displayed as units may or may not be physical units, and may be located in one position or may be distributed on a plurality of network units. Some or all of the units may be selected according to actual needs to achieve the objectives of the solutions of the embodiments.

In addition, functional units in the embodiments of the present disclosure may be integrated into one processor, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, a network device, or the like) to perform some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

The foregoing embodiments are merely intended to describe the technical solutions of the present disclosure, but not to limit the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A channel estimation method for a 2×2 multiple-input multiple-output (MIMO) system, comprising:
receiving, by a receive end, target signals respectively by using two receivers, wherein the target signal comprises target channel estimation sequence, wherein the target channel estimation sequence is a signal sequence generated by adding up a first transmission channel estimation sequence and a second transmission channel estimation sequence, wherein the first transmission channel estimation sequence is a signal sequence obtained after the first channel estimation sequence from the first transmitter has been transmitted on a channel, and wherein the second transmission channel estimation sequence is a signal sequence obtained after the second channel estimation sequence from the second transmitter has been transmitted on a channel, wherein the second channel estimation sequence is orthogonal to the first channel estimation sequence, and an auto-correlation function of the second channel estimation sequence is an impulse function; and
estimating, by the receive end, 2×2 channels between the two transmitters and the two receivers according to each of the target channel estimation sequences, the first channel estimation sequence, and the second channel estimation sequence.

2. The method according to claim 1, wherein the first channel estimation sequence is a sequence obtained by combining a Golay sequence a and a Golay sequence b in the 802.11ad protocol, wherein the second channel estimation sequence is a new sequence obtained by combining the Golay sequence a and the Golay sequence b in the 802.11ad protocol, and wherein an order of the Golay sequence a and the Golay sequence b in the second channel estimation sequence is reverse to an order of the Golay sequence a and the Golay sequence b in the first channel estimation sequence.

3. The method according to claim 2, wherein the first channel estimation sequence is [−Gb128, −Ga128, +Gb128, −Ga128, −Gb128, +Ga128, −Gb128, −Ga128], and wherein the second channel estimation sequence is [−Ga128, −Gb128, −Ga128, +Gb128, −Ga128, −Gb128, +Ga128, −Gb128].

4. The method according to claim 1, wherein estimating, by the receive end, the 2×2 channels between the two transmitters and the two receivers according to each of the target channel estimation sequences, the first channel estimation sequence, and the second channel estimation sequence comprises:
performing, by the receive end, a convolution operation on the target channel estimation sequence that is received by an a^{th} receiver and the first channel estimation sequence to obtain an estimation result of a channel between the first transmitter and the a^{th} receiver, wherein a is 1 or 2; and
performing, by the receive end, a convolution operation on the target channel estimation sequence received by the a^{th} receiver and the second channel estimation sequence to obtain an estimation result of a channel between the second transmitter and the a^{th} receiver, wherein a is 1 or 2.

5. A channel estimation method applied to a 2×2 multiple-input multiple-output (MIMO) system, comprising:
sending, by a first transmitter at a transmit end, a first source signal sequence, wherein the first source signal sequence comprises a first channel estimation sequence to be sent by the first transmitter, and wherein the first channel estimation sequence is a channel estimation sequence in an 802.11ad protocol; and
sending, by a second transmitter at the transmit end, a second source signal sequence, wherein the second source signal sequence comprises a second channel estimation sequence to be sent by the second transmitter, wherein the second channel estimation sequence is orthogonal to the first channel estimation sequence, and wherein an auto-correlation function of the second channel estimation sequence is an impulse function.

6. The method according to claim 5, wherein the first channel estimation sequence is a sequence obtained by combining a Golay sequence a and a Golay sequence b in the 802.11ad protocol, wherein the second channel estimation sequence is a new sequence obtained by combining the Golay sequence a and the Golay sequence b in the 802.11ad protocol, and wherein an order of the Golay sequence a and the Golay sequence b in the second channel estimation sequence is reverse to an order of the Golay sequence a and the Golay sequence b in the first channel estimation sequence.

7. The method according to claim 6, wherein the first channel estimation sequence is [−Gb128, −Ga128, +Gb128, −Ga128, −Gb128, +Ga128, −Gb128, −Ga128], and wherein the second channel estimation sequence is [−Ga128, −Gb128, −Ga128, +Gb128, −Ga128, −Gb128, +Ga128, −Gb128].

8. A receive end device applied to a 2×2 multiple-input multiple-output (MIMO) system, comprising:
two receivers, wherein the two receivers are configured to receive target signals, wherein the target signals are signal sequences obtained after source signal sequences from two transmitters at a transmit end have been transmitted on a channel, wherein the source signal sequences comprise a first channel estimation sequence from a first transmitter and a second channel estimation sequence from a second transmitter, wherein the first channel estimation sequence is a channel estimation sequence in an 802.11ad protocol, wherein the second channel estimation sequence is orthogonal to the first channel estimation sequence, wherein an auto-correlation function of the second channel estimation sequence is an impulse function, wherein the target signal comprises target channel estimation sequences, wherein the target channel estimation sequence is a signal sequence generated by adding up a first transmission channel estimation sequence and a second transmission channel estimation sequence, wherein the first transmission channel estimation sequence is a signal sequence obtained after the first channel estimation sequence from the first transmitter has been transmitted on a channel, and wherein the second transmission channel estimation sequence is a signal sequence obtained after the second channel estimation sequence from the second transmitter has been transmitted on a channel; and
a processor coupled to the two receivers and configured to estimate 2×2 channels between the two transmitters and the two receivers according to each of the target channel estimation sequences, the first channel estimation sequence, and the second channel estimation sequence, wherein the second channel estimation sequence is orthogonal to the first channel estimation sequence, and an auto-correlation function of the second channel estimation sequence is an impulse function.

9. The receive end device according to claim 8, wherein the first channel estimation sequence is a sequence obtained by combining a Golay sequence a and a Golay sequence b in the 802.11ad protocol, wherein the second channel estimation sequence is a new sequence obtained by combining the Golay sequence a and the Golay sequence b in the 802.11ad protocol, and wherein an order of the Golay sequence a and the Golay sequence b in the second channel estimation sequence is reverse to an order of the Golay sequence a and the Golay sequence b in the first channel estimation sequence.

10. The receive end device according to claim 9, wherein the first channel estimation sequence is [−Gb128, −Ga128, +Gb128, −Ga128, −Gb128, +Ga128, −Gb128, −Ga128], and the second channel estimation sequence is [−Ga128, −Gb128, −Ga128, +Gb128, −Ga128, −Gb128, +Ga128, −Gb128].

11. The receive end device according to claim 8, wherein the processor is further configured to:
perform a convolution operation on a target channel estimation sequence received by an a^{th} receiver and the first channel estimation sequence to obtain an estimation result of a channel between the first transmitter and the a^{th} receiver, wherein a is 1 or 2; and
perform a convolution operation on the target channel estimation sequence received by the a^{th} receiver and the second channel estimation sequence to obtain an estimation result of a channel between the second transmitter and the a^{th} receiver, wherein a is 1 or 2.
